(19) United States
(12) Patent Application Publication
(10) Pub. No.: US 2024/0208357 A1
(43) Pub. Date: Jun. 27, 2024

(54) INFORMATION PROCESSING METHOD

(71) Applicant: TOYOTA JIDOSHA KABUSHIKI KAISHA, Toyota-shi (JP)

(72) Inventors: Ai MIYATA, Osaka (JP); Ibuki SHIMADA, Miyoshi-shi (JP); Hiroki TAKEISHI, Tokyo (JP); Koki MORIYA, Nagakute-shi (JP); Koji UEDA, Hunabashi-shi (JP)

(73) Assignee: TOYOTA JIDOSHA KABUSHIKI KAISHA, Toyota-shi (JP)

(21) Appl. No.: 18/507,391

(22) Filed: Nov. 13, 2023

(30) Foreign Application Priority Data
Dec. 22, 2022 (JP) 2022-205859

(51) Int. Cl. B60L 53/66; B60L 53/68

(52) U.S. Cl. CPC B60L 53/665; B60L 53/68

(57) ABSTRACT

An information processing method using an information processing device capable of communicating with a charging device, the information processing method including: detecting that a charging cable of a charging device is physically connected to a vehicle and locked; and unlocking the charging cable when determining that a charging fee billing process for a user of the vehicle has been completed.

### CROSS-REFERENCE TO RELATED APPLICATION

This application claims priority to Japanese Patent Application No. 2022-205859 filed on Dec. 22, 2022, incorporated herein by reference in its entirety.

### BACKGROUND

### 1. Technical Field

The present disclosure relates to an information processing method.

### 2. Description of Related Art

Hitherto, there is known a service in which a power supply vehicle rushes to a target vehicle and supplies electric power to the target vehicle when a power supply request to the target vehicle is made on an application (see, for example, NIO LIMITED, “NIO Power”, [online], 2022, [Searched on Dec. 14, 2022], Internet <URL: https://www.nio.com/nio-power>).

### SUMMARY

In the background art described above, when a user is to be billed after completion of power supply but a service representative for the billing is not in a power supply place, the user may leave the power supply place in an unbilled state.

In view of such circumstances, an object of the present disclosure is to securely complete billing of a charging fee.

An information processing method according to one embodiment of the present disclosure is an information processing method to be performed by an information processing device configured to communicate with a charging device. The information processing method includes: detecting that a charging cable of the charging device is physically connected to a vehicle and is locked; and unlocking the charging cable when determination is made that a billing process for a charging fee on a user of the vehicle has been completed.

According to the embodiment of the present disclosure, the billing of the charging fee can be completed securely.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram of an information processing system;

FIG. 2 is a block diagram illustrating a configuration of an information processing device;

FIG. 3 is a block diagram illustrating a configuration of a user terminal;

FIG. 4 shows a charging cable; and

FIG. 5 is a flow chart illustrating an operation of an information processing device.

### DETAILED DESCRIPTION OF EMBODIMENTS

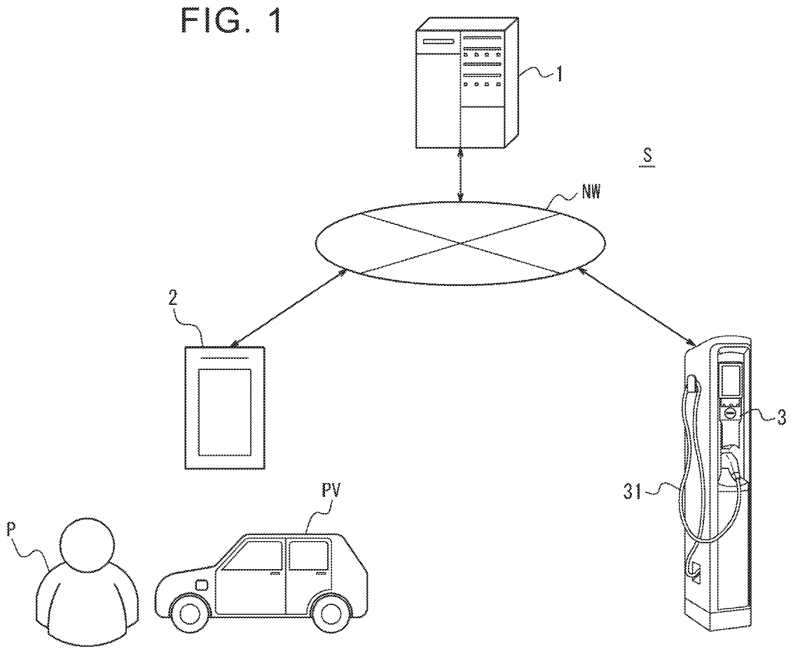

FIG. 1 is a schematic diagram of an information processing system S according to the present embodiment. The information processing system S includes an information processing device 1, a user terminal 2, and a charging device 3 that can communicate with each other via a network NW. The network NW includes, for example, a mobile communication network, a fixed communication network, or the Internet.

User terminal 2 is operated by user P. The user P drives the vehicle PV or rides on the vehicle PV. In this case, the vehicle PV is a battery electric vehicle including a battery, but is not limited thereto. The charging device 3 includes a charging cable 31. The charging device 3 supplies power to battery electric vehicle or the like via the charging cable 31. The charging device 3 is installed in a charging station. Alternatively, the charging device 3 May be mounted on another vehicle that moves to a position on the vehicle PV and supplies power to the vehicle PV. This movement is referred to as, for example, running.

In FIG. 1, the information processing device 1, the user terminal 2, and the charging device 3 are illustrated one by one for convenience of explanation. However, the number of the information processing device 1, the user terminal 2, and the charging device 3 is not limited to this. For example, the processes executed by the information processing device 1 according to the present embodiment may be executed by a plurality of the information processing devices 1 disposed in a distributed manner.

The information processing device 1 is installed in facilities such as a data center. The information processing device 1 is, for example, a computer such as a server belonging to a cloud computing system or other computing systems.

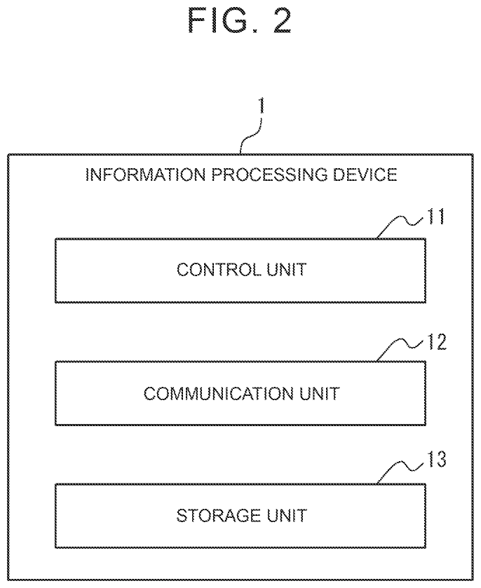

In FIG. 2, the internal configuration of the information processing device 1 will be described in detail.

The information processing device 1 includes the control unit 11, the communication unit 12, and a storage unit 13. The constituent components of the information processing device 1 are connected so as to be able to communicate with each other via a dedicated line, for example.

The control unit 11 includes, for example, one or more general-purpose processors including Central Processing Unit (CPU) or Micro Processing Unit (MPU). The control unit 11 May include one or more dedicated processors specialized for a specific process. The control unit 11 May include one or more dedicated circuits instead of including the processor. The dedicated circuitry may be, for example, Field-Programmable Gate Array (FPGA) or Application Specific Integrated Circuit (ASIC). The control unit 11 May include an Electronic Control Unit (ECU). The control unit 11 transmits and receives information via the communication unit 12.

The communication unit 12 includes a communication module corresponding to one or more wired or wireless Local Area Network (LAN) standards for connecting to a network NW. The communication unit 12 May include modules corresponding to one or more mobile communication standards including Long Term Evolution (LTE), 4th Generation (4G), or 5th Generation (5G). The communication unit 12 may include a communication module and the like conforming to one or more short-range communication standards or specifications including Bluetooth (registered trademark), Air Drop (registered trademark), infrared data association (IrDA), ZigBee (registered trademark), FeliCa (registered trademark), or radio frequency identifier (RFID). The communication unit 12 transmits and receives information via the network NW.

The storage unit 13 includes a semiconductor memory, a magnetic memory, an optical memory, or a combination of at least two of them. However, the disclosure is not limited to this. The semiconductor memory is, for example, a random access memory (RAM) or a read-only memory (ROM). The RAM is, for example, a static random access memory

(SRAM) or a dynamic random access memory (DRAM). The ROM is, for example, an electrically erasable programmable read-only memory (EEPROM). The storage unit 13 May function as, for example, a main storage device, an auxiliary storage device, or a cache memory. The storage unit 13 May store information on the result of analysis or processing by the control unit 11. The storage unit 13 May store various kinds of information and the like related to the operation or control of the information processing device 1. The storage unit 13 May store a system program, an application program, embedded software, and the like. The storage unit 13 May be provided outside the information processing device 1 and accessed from the information processing device 1.

The user terminal 2 is, for example, a mobile terminal such as a mobile phone, a smartphone, a wearable device, or a tablet. Alternatively, the user terminal 2 May be a general-purpose device such as a PC or a dedicated device. PC is an abbreviation for personal computer. User terminal 2 is operated by user P.

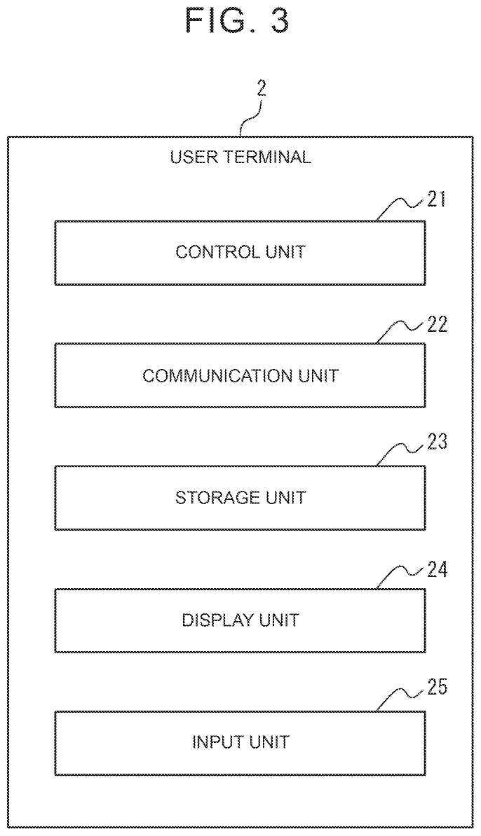

In FIG. 3, the internal configuration of the user terminal 2 will be described in detail.

The user terminal 2 includes a control unit 21, a communication unit 22, a storage unit 23, a display unit 24, and an input unit 25. Each component of the user terminal 2 is communicably connected to each other via, for example, a dedicated line.

The hardware configuration of the control unit 21, the communication unit 22, and the storage unit 23 of the user terminal 2 May be the same as the hardware configuration of the control unit 11, the communication unit 12, and the storage unit 13 of the information processing device 1. The description here is omitted.

The display unit 24 is, for example, a display. The display is, for example, an LCD or an organic EL display. The term “LCD” is an abbreviation for “liquid crystal display”. EL is an abbreviation for electro luminescence. Instead of being provided in the user terminal 2, the display unit 24 May be connected to the user terminal 2 as an external output device. As a connection method, for example, any method such as a universal serial bus (USB), a high-definition multimedia interface (HDMI) (registered trademark), or Bluetooth (registered trademark) can be used.

The input unit 25 is, for example, a physical key, a capacitive key, a pointing device, a touch screen integrally provided with a display, or a microphone. The input unit 25 receives an operation of inputting information used for the operation of the user terminal 2. Instead of being provided in the user terminal 2, the input unit 25 May be connected to the user terminal 2 as an external input device. As a connection method, for example, any method such as a universal serial bus (USB), a high-definition multimedia interface (HDMI) (registered trademark), or Bluetooth (registered trademark) can be used. The term “USB” is an abbreviation for “universal serial bus”. The term “HDMI (registered trademark)” is an abbreviation for “high-definition multimedia interface”.

Hereinafter, an information processing method by the information processing system S will be described in detail. Here, a scene in which the user P performs charging from the charging device 3 to the vehicle PV will be described. The user P physically connects the charging cable 31 of the charging device 3 to the vehicle PV.

The control unit 11 of the information processing device 1 detects that the charging cable 31 of the charging device 3 is physically connected to the vehicle PV and locked. The locking process may be performed by the information processing device 1 that has detected the physical connection of the charging cable 31, or may be performed by the charging device 3 without an instruction from the information processing device 1.

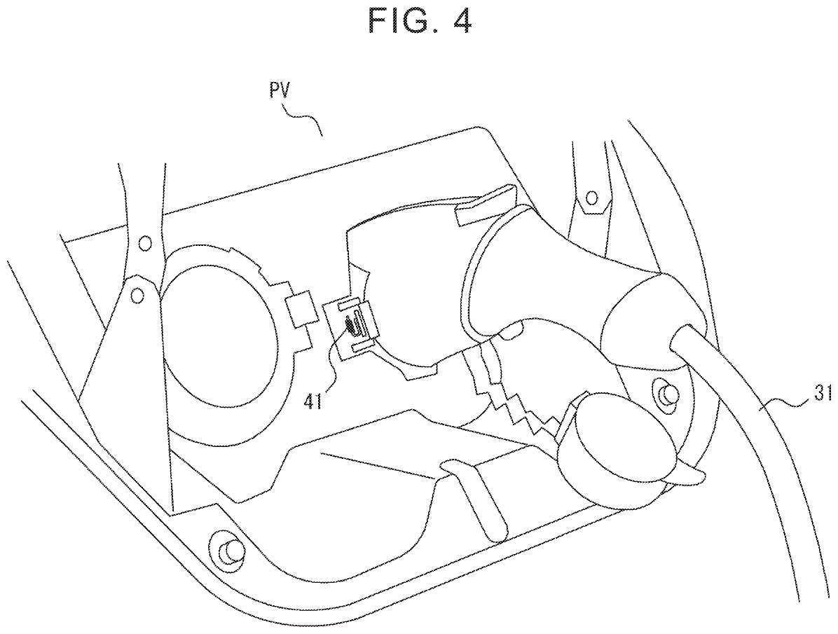

As shown in FIG. 4, the charging cable 31 is physically locked to the vehicle PV. That is, the charging cable 31 is physically fixed to the vehicle PV and does not come off the vehicle PV. The physical locking may be performed, for example, by a physical locking device 41 included in at least one of the vehicle PV and the charging cable 31.

The control unit 11 detects that charging by the charging device 3 is completed. As an additional example, the control unit 11 May start charging after securing the charge amount (that is, after the credit approval is performed) of the usage limit of the credit card used by the user P.

The control unit 11 determines whether the charging fee billing process for the user P of the vehicle PV has been completed. For example, the control unit 11 May settle the charging fee from the credit card registered by the user P. Further, the control unit 11 may settle the charging fee from the credit card inserted into the charging device 3 or the like by the user P. Credit cards are an example, and other payment cards, such as debit cards, may be utilized.

As an additional example, the control unit 11 May determine whether or not the billing process has been completed when a lock release request is received from the user terminal 2.

When the control unit 11 determines that the billing process of the charging fee for the user P has been completed, it unlocks the charging cable 31. The user P can disconnect the charging cable 31 from the vehicle PV. Unless the charging fee billing process is completed, the charging cable 31 is not unlocked.

As an additional example, the control unit 11 May increase the payment amount of the charging fee in accordance with a time period from the completion of charging until the completion of the billing process.

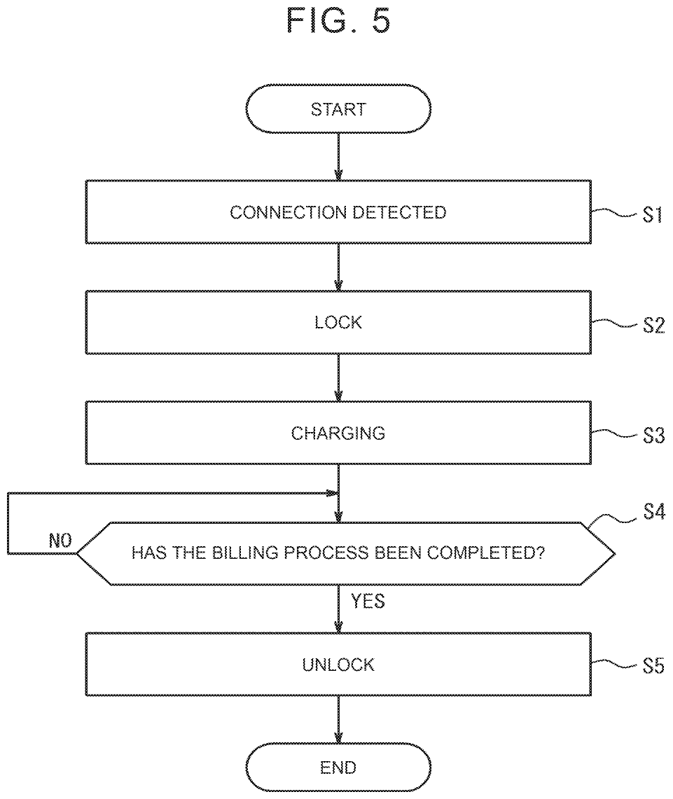

In FIG. 5, an information processing method by the control unit 11 of the information processing device 1 will be described.

In S1, the control unit 11 detects that the charging cable 31 of the charging device 3 is physically connected to the vehicle PV. In S2, the control unit 11 locks the charging cable 31. Alternatively, the locking may be performed by the charging device 3 without communicating with the information processing device 1. In S3, the control unit 11 charges the vehicle PV. Alternatively, the charging may be performed by the charging device 3 without communicating with the information processing device 1.

In S4, the control unit 11 determines whether or not the charging fee billing process for the user P has been completed. The control unit 11 executes S4 again when No is performed by S4. When S4 is Yes, the control unit 11 unlocks the charging cable 31 in S5.

As described above, according to the present embodiment, the operation of the control unit 11 of the information processing device 1 includes detecting that the charging cable 31 is physically connected to the vehicle PV and locked, and unlocking the charging cable 31 when it is determined that the charging fee billing process for the user P of the vehicle PV has been completed. With this configuration, the information processing device 1 releases the lock of the charging cable 31 after the billing process is completed, so that it is possible to prevent the user from leaving the charging cable in an unpaid state.

Therefore, the information processing device 1 can reliably complete billing of the charging fee.

In addition, according to the present embodiment, the operation of the control unit 11 includes starting charging after securing the charge amount among the usage limit of the credit card used by the user P. With this configuration, the information processing device 1 can more reliably complete billing.

Further, according to the present embodiment, the operation of the control unit 11 includes increasing the payment amount of the charging fee in accordance with the time from the completion of charging until the completion of the billing process. With this configuration, the information processing device 1 can promptly prompt payment by the user P.

Further, according to the present embodiment, the operation of the control unit 11 includes locking the charging cable 31 when it is detected that the charging cable 31 is connected to the vehicle PV. With this configuration, the information processing device 1 can lock the information processing device 1 itself.

In addition, according to the present embodiment, the operation of the control unit 11 includes determining whether or not the billing process has been completed when a lock release request is received from the user terminal 2. With this configuration, the information processing device 1 can perform the determination at an appropriate timing.

Although the present disclosure has been described above based on the drawings and the embodiment, it should be noted that those skilled in the art may make various modifications and alterations thereto based on the present disclosure. Other changes may be made without departing from the scope of the present disclosure. For example, the functions included in each means or step can be rearranged so as not to be logically inconsistent, and a plurality of means or steps can be combined into one or divided.

For example, in the above-described embodiment, a program that executes all or a part of the functions or processes of the information processing device 1, the user terminal 2, or the charging device 3 can be recorded in a computer-readable recording medium. The computer-readable recording medium includes a non-transitory computer-readable medium such as a magnetic recording device, an optical disc, a magneto-optical recording medium, or a semiconductor memory. Distribution of the program is performed, for example, by selling, transferring, or lending a portable recording medium such as a Digital Versatile Disc (DVD) or a Compact Disc Read Only Memory (CD-ROM) in which the program is recorded. Further, the distribution of the program may be performed by storing the program in a storage of a server and transmitting the program from the server to another computer. Further, the program may be provided as a program product. The present disclosure can also be realized as a program that can be executed by a processor.

What is claimed is:

1. An information processing method to be performed by an information processing device configured to communicate with a charging device, the information processing method comprising:
detecting that a charging cable of the charging device is physically connected to a vehicle and is locked; and
unlocking the charging cable when determination is made that a billing process for a charging fee on a user of the vehicle has been completed.

2. The information processing method according to claim 1, further comprising starting charging after securing the charging fee within a usage limit of a credit card used by the user.

3. The information processing method according to claim 1, further comprising increasing a payment amount of the charging fee based on a period from completion of charging to completion of the billing process.

4. The information processing method according to claim 1, further comprising locking the charging cable when connection of the charging cable to the vehicle has been detected.

5. The information processing method according to claim 1, further comprising determining whether the billing process has been completed when an unlocking request is received from a user terminal of the user.
